(19) United States
(12) Patent Application Publication
(10) Pub. No.: US 2012/0086529 A1
(43) Pub. Date: Apr. 12, 2012

(54) DEVICE INTEGRATING BOTH THE DIGITAL SWITCH AND HAND SWITCH

(76) Inventor: Hung-Yi Lin, Taipei (TW)

(21) Appl. No.: 12/902,201

(22) Filed: Oct. 12, 2010

(51) Int. Cl. H01H 89/06

(52) U.S. Cl. 335/1

(57) ABSTRACT

A device integrating a digital switch and a hand switch, which includes one hand switch having a primary terminal being fixed at one side, and a secondary terminal and a third terminal being fixed at another side respectively, thereat, either the said secondary terminal or said third terminal is able to be connected with the said primary terminal via specifiable switching operations; one automatic switch having a fourth terminal being fixed at one side, and a fifth terminal and a sixth terminal being fixed at another side respectively, whereat, either the said fifth terminal or said sixth terminal is able to be connected with the said fourth terminal via specifiable switching operations; and wherein, upon the occurrence of a malfunction in the automatic switch, the device is allowable to turn on or off manually.

### BACKGROUND OF THE INVENTION

1. Field of the Invention

The present invention relates generally to a kind of device integrating a digital switch and a hand switch, and more specifically it relates to a device for integrating a digital switch with a hand switch in such a way that it can still be controlled manually by a user upon the occurrence of any malfunction or non-availability of its automatic switching function.

2. The Prior Art

FIG. 1 is a schematic view showing a known device integrating a digital switch and a hand switch, in which, it comprises the control unit 11, electrical appliance 12 and hand switch 13. In the structure of a known device integrating both digital switch and hand switch, thereat, the hand switch 13 is indirectly linked to the electrical appliance 12 via control unit 11. And control unit 11 can detect the operational status of hand switch 13 by measuring either its electrical voltage or current. Therefore, when a user is turning on a hand switch 13, the control unit 11 can detect an operating signal from the hand switch 13 immediately and then it will energize the electrical appliance 12 via a component such as relay etc. The control unit 11 has various transmission interfaces, e.g. network transmission interface etc., so that a user can easily control the control unit 11 directly via another device such as computer etc. to operate the said electrical appliance 12 without using the hand switch 13 at all. Certainly, it is allowable to connect the control unit 11 with a sensing unit to operate the said electrical appliance 12 directly according to the sensing signal receiving from the said sensing unit and hence achieving the goal of intelligent appliance control.

Though the known device integrating both digital switch and hand switch can provide both the provide manual control and automatic control functions, however, since the hand switch can only control/operate the electrical appliance indirectly through the control unit, therefore, upon the occurrence of a malfunction in the said control unit, both the manual control and automatic control functions will fail synchronously and hence it will be impossible to switch on the said electrical appliance at all.

The disadvantages of the known technique are as follows:

1. The known device for integrating the digital switch and hand switch, wherein, its manual control function will fail synchronously while automatic control function is unworkable so that it is impossible to switch on relevant electrical appliance at all; and

2. The known device for integrating the digital switch and hand switch, wherein, its switching functions will become completely unworkable once the automatic control function fails, ad under this circumstance, a user will not be able to operate relevant electrical appliance after its operational functions have been recovered which makes the user feel very inconvenient.

Thus, how to improve above-mentioned disadvantages of the known device so that a user still can operate relevant electrical appliance normally upon the occurrence of a malfunction in the automatic control function has become a great concern to the present invention.

### SUMMARY OF THE INVENTION

The purpose of present invention lies in providing an novel and advanced integration device of digital switch and hand switch, which adopts two sets of single-pole double-throw switches that can be cascaded together; and wherein, one switch is able to provide a manual control function and another switch can be operated through a control unit to provide an automatic control function; and thereat, because the single-pole double-throw switch will contact with any one of the terminals positioned on the other side of said switch all the time, therefore, all functions of the hand switch will still be operated normally without being affected by the defective automatic control switch even though there is a malfunction of either the automatic control switch or control unit.

In order to fulfill the above-mentioned purpose, hence, the present invention presents a kind of device integrating a digital switch and a hand switch, which comprises:

One hand switch, wherein, there is a primary terminal being fixed at the primary side of the said hand switch, and in addition, a secondary terminal and a third terminal is being fixed at the secondary side of the said hand switch respectively, thereat, either the said secondary terminal or said third terminal is able to be connected with the said primary terminal via specifiable switching operations;

One automatic switch, wherein, there is a fourth terminal being fixed at the primary side of the said automatic switch, and moreover, a fifth terminal and a sixth terminal is being fixed at the secondary side of the said automatic switch respectively, whereat, either the said fifth terminal or said sixth terminal is able to be connected with the said fourth terminal via specifiable switching operations;

Wherein, upon the occurrence of a malfunction in the said automatic switch which makes the said fourth terminal unable to be switched out of the said fifth terminal, and under this circumstance, it is allowable to connect the said primary terminal with the said secondary terminal to energize a direct link between the said primary terminal and the said fourth terminal, or instead, it is allowable to connect the said primary terminal to the said third terminal to disenergize a direct link between the said primary terminal and the said fourth terminal accordingly via the operation of the said hand switch; furthermore, during the occurrence of a malfunction in the said automatic switch which makes the said fourth terminal unable to be switched out of the said sixth terminal, and under this circumstance, it is allowable to connect the said primary terminal to the said third terminal to energize a direct link between the said primary terminal and the said fourth terminal, or instead, it is allowable to connect the said primary terminal with the said secondary terminal to disenergize a direct link between the said primary terminal and the said fourth terminal accordingly via the operation of the said hand switch thereto.

A device integrating both the digital switch and hand switch as defined in preceding paragraph, in which, the said hand switch and the said automatic switch is actually a kind of single-pole double-throw switch.

A device integrating both the digital switch and hand switch as defined in preceding paragraph, wherein, the said automatic switch is actually a relay.

A device integrating both the digital switch and hand switch as defined in preceding paragraph, in which, it even includes one control unit, and thereat, its automatic control function is performed by the said control unit, moreover, the said control unit is able to receive a signal and then respond to the instruction in accordance with such signal by shifting the connectivity among the said fourth terminal, the said the fifth terminal and the said sixth terminal of the said automatic switch.

A device integrating both the digital switch and hand switch as defined in preceding paragraph, wherein, the said control unit is able to receive such signal via a transmission interface, such as network etc.

A device integrating a digital switch and a hand switch as claimed in preceding paragraph, wherein, it further comprises one detecting unit, and thereat, the said detecting unit is able to detect the connectivity among the said primary terminal, the said secondary terminal and the said third terminal of the said hand switch, and meanwhile it will deliver the primary detection result back to the said control unit accordingly.

A device integrating both the digital switch and hand switch as defined in preceding paragraph, wherein, it is available to cascade an electrical appliance to the said primary terminal as well as the said fourth terminal, and thereat, the said detecting unit is parallel to the said electrical appliance, and in addition, it is able to detect the connectivity among the said primary terminal, the said secondary terminal and the said third terminal of the said hand switch by measuring the electrical voltage difference between both ends of the said electrical appliance thereto.

A device integrating a digital switch and a hand switch as defined in preceding paragraph, in which, the said detecting unit is being cascaded at a position locating between the said primary terminal and the said fourth terminal, and moreover, it is able to detect the connectivity among the said primary terminal, the said secondary terminal and the said third terminal of the said hand switch by measuring the amount of electrical current passing through these terminals thereof.

A device integrating a digital switch and a hand switch as defined in preceding paragraph, wherein, it is available to cascade an electrical appliance at a position locating between the said primary terminal and the said fourth terminal, and thereby it will be able to operate/control the said hand switch or the said automatic switch accordingly.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic view showing a known device integrating a digital switch and a hand switch;

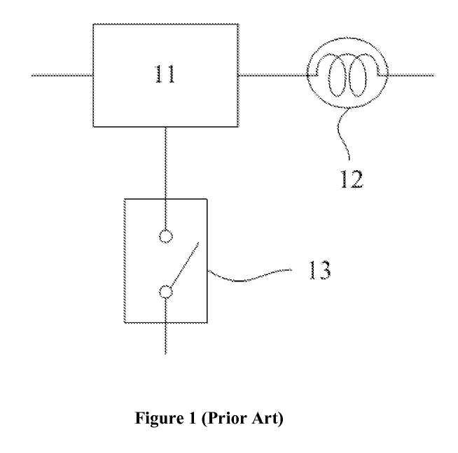

FIG. 2 is a schematic view showing a preferred embodiment in accordance with the present invention, in which, the operational status of hand switch is being detected by measuring its electrical voltage; and

FIG. 3 is a schematic view showing another preferred embodiment in accordance with the present invention, in which, the operational status of hand switch is being detected by measuring the amount of its electrical current; and

FIG. 4 is a schematic view showing another preferred embodiment in accordance with the present invention, in which, it has been equipped with a plurality of hand switches thereof.

### DETAILED DESCRIPTION OF THE PREFERRED EMBODIMENT

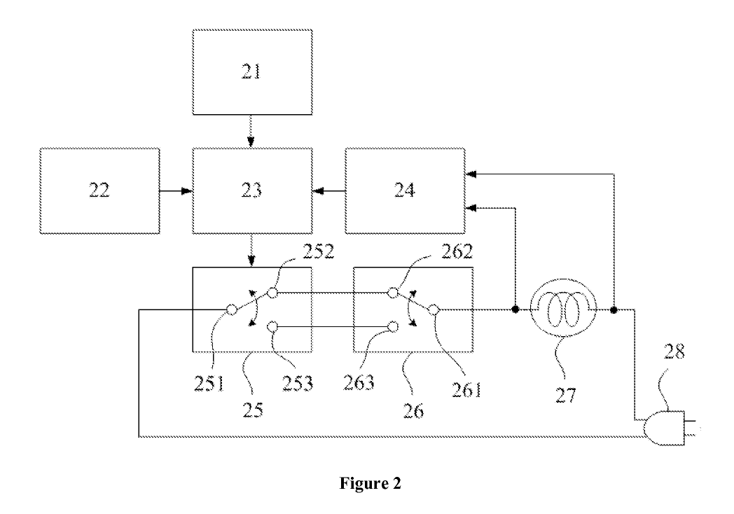

With reference to FIG. 2, it is a schematic view showing a preferred embodiment in accordance with the present invention, in which, the operational status of hand switch is being detected by measuring its electrical voltage, and wherein, it comprises the sensing unit 21, computer 22, control unit 23, detecting unit 24, automatic switch 25, terminals 251, 252, 253, 261, 262, and 263, the hand switch 26, electrical appliance 27 and power supply 28. There is a terminal 261 being fixed at the primary side of the hand switch 26, and in addition, there are terminals 262 and 263 being fixed at the secondary side of the said hand switch respectively, and moreover, there is a terminal 251 being fixed at the primary side of the automatic switch 25, and also a terminal 252 and terminal 253 are being fixed at the secondary side of the said automatic switch 25 respectively. Whereat, terminal 252 and terminal 253 are being linked with terminal 262 and terminal 263 respectively. Being linked to the automatic switch 25, the control unit 23 is able to turn on or turn off the said automatic switch 25. The electrical appliance 27, for instance the electric lights or home appliances etc., and the power supply 28 are being cascaded at a position locating between terminal 251 and terminal 261. Wherein, a kind of single-pole double-throw switch can be used as either the automatic switch 25 or the hand switch 26, and a relay can be used as an automatic switch 25.

Terminal 261 fixed on the hand switch 26 will maintain a continuous connection with either terminal 262 or terminal 263, and under this circumstance, when a user turn on the hand switch 26 with his (her) hand, the terminal 261 will then be shifted to another terminal, e.g. terminal 263 (or terminal 262), from the original terminal, e.g. terminal 262 (or terminal 263). Similarly, the terminal 251 fixed on the automatic switch 25 will maintain a continuous connection with either terminal 252 or terminal 253, and under this circumstance, when the control unit 23 is switching on the automatic switch 25, the terminal 251 will then be shifted to another terminal, e.g. terminal 253 (or terminal 252), from the original terminal, e.g. terminal 252 (or terminal 253).

Supposedly, at present, the terminal 261 is being connected to terminal 262 on the said hand switch 26, and by the time while control unit 23 would like to turn on the said electrical appliance 27, it will have to connect the terminal 251 with terminal 252; whereas, if the terminal 261 is being connected to terminal 263 on the said hand switch 26, and by the time while control unit 23 would like to turn on the electrical appliance 27, it will have to connect the terminal 251 with terminal 253 instead. Whereby, to operate the overall system correctly, it is very important for the control unit 23 to find out the actual connection status of terminal 261 fixed on the said hand switch 26. For this particular problem, it can be easily resolved while control unit 23 is able to utilize the function provided by the detecting unit 24. Whereat, the said detecting unit 24 is being cascaded to both ends of the said electrical appliance 27, and whereby, the detecting unit 24 is able to determine the actual connection status at the terminal 261 fixed on the hand switch 26 by measuring the electrical voltage at each end of the said electrical appliance 27, and then it will deliver the detection result back to the said control unit 23. Whereby, the control unit 23 will react upon receiving relevant detection results.

Upon the occurrence of a malfunction in the automatic switch 25 which makes the terminal 251 unable to be switched out of the terminal 252, and under this circumstance, it is allowable to connect terminal 261 with terminal 262 fixed on the said hand switch 26 to turn on the electrical appliance 27, or instead, it is allowable to connect terminal 261 with terminal 263 to turn off the said electrical appliance 27; furthermore, during the occurrence of a malfunction in the automatic switch 25 which makes the terminal 251 unable to be switched out of terminal 253, and under this circumstance, it is allowable to connect terminal 261 with terminal 263 fixed on the said hand switch 26 to turn on the electrical appliance 27, or instead, it is allowable to connect terminal 261 with terminal 262 to turn off the said electrical appliance 27. Thus, a user can still control/operate relevant electrical appliance 27 via the said hand switch 26 even though the occurrence of any malfunction or non-availability of the said automatic switching 25.

On the other hand, the user can easily control the control unit 23 directly via another device such as computer 22 etc. to operate the said electrical appliance 27. Whereby, the said computer 22 can utilize any available transmission interface, e.g. WLAN or internet etc., to communicate with the control unit 23 directly. Additionally, the said control unit 23 is able to be connected with a sensing unit 21 to detect ambient conditions, including brightness, temperature or humidity etc., and meanwhile, it is able to control/operate the electrical appliance 27 by responding to the detection results received from the said sensing unit 21, for instance, to turn on the electric lights automatically while the brightness is low or switching on the air conditioner while the temperature is high.

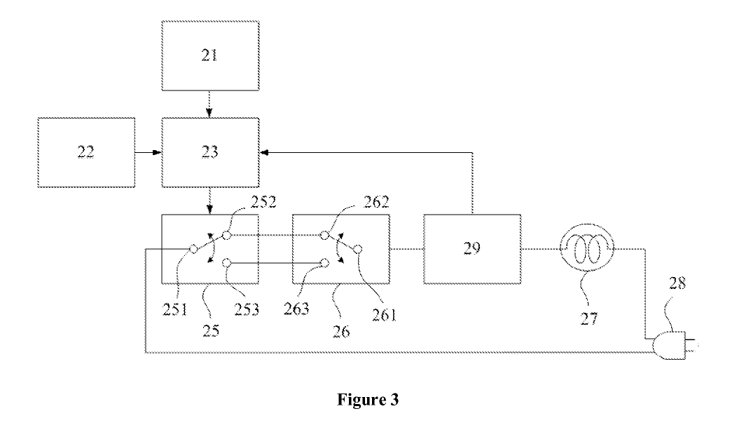

With reference to FIG. 3, it is a schematic view showing another preferred embodiment in accordance with the present invention, in which, the operational status of hand switch is being detected by measuring the amount of its electrical current, and wherein, it comprises the sensing unit 21, computer 22, control unit 23, automatic switch 25, terminals 251, 252, 253, 261, 262, and 263, the hand switch 26, electrical appliance 27, power supply 28 and detecting unit 29. Whereby, the detecting unit 29 can also be cascaded into the automatic switch 25, hand switch 26, electrical appliance 27 as well as power supply 28, and moreover, it is able to determine the actual operational status of the hand switch 26 by measuring the amount of loop current.

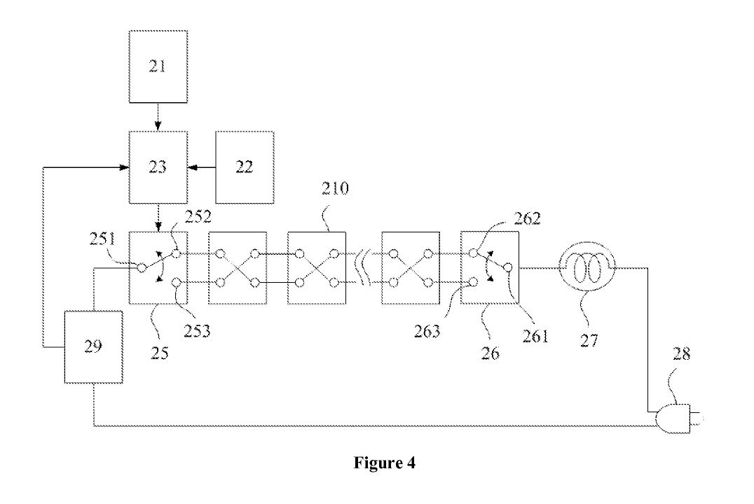

With reference to FIG. 4, it is a schematic view showing another preferred embodiment in accordance with the present invention, in which, it has been equipped with a plurality of hand switches thereof. And wherein, it comprises the sensing unit 21, computer 22, control unit 23, digital switch 25, terminals 251, 252, 253, 261, 262, and 263, the hand switch 26, electrical appliance 27, power supply 28, detecting unit 29 as well as the four-way hand switch 210. Whereby, if one would like to set up a plurality of hand switches, it is allowable to cascade a plurality of four-way hand switches 210 into a position locating between the said digital switch 25 and the said hand switch and under this circumstance the said digital switch 25 will be able to link with the said hand switch 26 indirectly via the said a plurality of four-way hand switches 210. Whereby, the said four-way hand switches 210 has two types of shifting mode, and thereby, suppose that Mode 1 is being selected, the terminals of the said four-way hand switch 210 will be connected parallelly (i.e. two upper terminals can be conducted to each other, and two lower terminals can be conducted to each other as well), and if Mode 2 is being selected, then terminals of the said four-way hand switch 210 will be cross-connected (i.e. the top left terminal can be conducted to the bottom right terminal, and instead, the top right terminal can be conducted to the bottom left terminal), and in this way it will be satisfy the requirement for setting up a plurality of hand switches simply by cascading a four-way hand switches 210 into a position locating between the said digital switch 25 and the said hand switch 26.

The advantages of present invention are as follows:

1. The device integrating a digital switch and a hand switch provided by the present invention in such way that a user can still control/operate relevant electrical appliance correctly via the hand switch upon the occurrence of any malfunction or non-availability of its automatic switching function; and

2. The device integrating a digital switch and a hand switch provided by the present invention in such a way that a user will never have to wait for the maintenance anymore, because he or she can still control/operate relevant electrical appliance correctly via the hand switch function thereof.

From the foregoing description, the novel and advanced device integrating both the digital switch and hand switch in accordance with the present invention can still control/operate relevant electrical appliances correctly via its hand operational function during the occurrence of a malfunction in automatic control function, whereas, all modifications and changes including various applications, different designs for relevant switches, or even different transmission interfaces designed for the control unit etc., any similar structure consisting of two sets of single-pole double-throw switches or single-pole multiple-throw switches may be made without departing from the scope of the present invention at all.

Although the present invention has been described with reference to the preferred embodiment that can be achieved easily by a skillful person familiar with this particular technology thereof, it is apparent to those skilled in the art that a variety of modifications and changes may be made without departing from the scope of the present invention which is intended to be defined by the appended claims.

What is claimed is:

1. A device integrating a digital switch and a hand switch, which comprises:
one hand switch, wherein, there is a primary terminal being fixed at the primary side of the said hand switch, and in addition, a secondary terminal and a third terminal is being fixed at the secondary side of the said hand switch respectively, and thereat, either the said secondary terminal or said third terminal is able to be connected with the said primary terminal via specifiable switching operations;
one automatic switch, wherein, there is a fourth terminal being fixed at the primary side of the said automatic switch, and moreover, a fifth terminal and a sixth terminal is being fixed at the secondary side of the said automatic switch respectively, and thereat, either the said fifth terminal or said sixth terminal is able to be connected with the said fourth terminal via specifiable switching operations; and
wherein, upon the occurrence of a malfunction in the said automatic switch which makes the said fourth terminal unable to be switched out of the said fifth terminal, and under this circumstance, it is allowable to connect the said primary terminal with the said secondary terminal with the said hand switch to energize a direct link between the said primary terminal and the said fourth terminal, or instead, it is allowable to connect the said primary terminal to the said third terminal to disenergize a direct link between the said primary terminal and the said fourth terminal accordingly via the operation of the said hand switch; furthermore, during the occurrence of a malfunction in the said automatic switch which makes the said fourth terminal unable to be switched out of the said sixth terminal, and under this circumstance, it is allowable to connect the said primary terminal to the said third terminal with the said hand switch to energize a direct link between the said primary terminal and the said fourth terminal, or instead, it is allowable to connect the said primary terminal with the said secondary terminal to disenergize a direct link between the said primary terminal and the said fourth terminal accordingly via the operation of the said hand switch thereto.

2. A device integrating a digital switch and a hand switch as claimed in claim 1, wherein, the said hand switch and the said automatic switch is actually a kind of single-pole double-throw switch.

3. A device integrating a digital switch and a hand switch as claimed in claim 1, wherein, the said automatic switch is actually a relay.

4. A device integrating a digital switch and a hand switch as claimed in claim 1, wherein, it even includes one control unit, and thereat, the relevant automatic control function is preferably performed by the said control unit, moreover, the said control unit is able to receive a signal and then respond to the instruction in accordance with such signal by shifting the connectivity among the said fourth terminal, the said the fifth terminal and the said sixth terminal of the said automatic switch.

5. A device integrating a digital switch and a hand switch as claimed in claim 4, wherein, the said control unit is able to receive such signal via a transmission interface, such as network etc.

6. A device integrating a digital switch and a hand switch as claimed in claim 4, wherein, it further comprises one detecting unit, and thereat, the said detecting unit is able to detect the connectivity among the said primary terminal, the said secondary terminal and the said third terminal of the said hand switch, and meanwhile it will deliver the primary detection result back to the said control unit accordingly.

7. A device integrating a digital switch and a hand switch as claimed in claim 6, wherein, it is available to cascade an electrical appliance to the said primary terminal as well as the said fourth terminal, and thereat, the said detecting unit is parallel to the said electrical appliance, and in addition, it is able to detect the connectivity among the said primary terminal, the said secondary terminal and the said third terminal of the said hand switch by measuring the electrical voltage difference between both ends of the said electrical appliance thereto.

8. A device integrating a digital switch and a hand switch as claimed in claim 6, wherein, the said detecting unit is being cascaded at a position locating between the said primary terminal and the said fourth terminal, and moreover, it is able to detect the connectivity among the said primary terminal, the said secondary terminal and the said third terminal of the said hand switch by measuring the amount of electrical current passing through these terminals thereof.

9. A device integrating a digital switch and a hand switch as claimed in claim 1, wherein, it is available to cascade an electrical appliance at a position locating between the said primary terminal and the said fourth terminal, and thereby it will be able to operate/control the said hand switch or the said automatic switch accordingly.
